(19) United States
(12) Patent Application Publication
(10) Pub. No.: US 2002/0105149 A1
(43) Pub. Date: Aug. 8, 2002

(54) Centrifugal dental drill bit chuck

(76) Inventor: L. Emery Karst, Salem, OR (US)

Correspondence Address: L. EMERY KARST, 317 SANRODEE DR SE, SALEM, OR, 97301, US

(21) Appl. No.: 10/051,919

(22) Filed: Jan. 22, 2002

Related U.S. Application Data
(60) Provisional application No. 60/259,616, filed on Jan. 3, 2001.

(51) Int. Cl. B23B 31/14

(52) U.S. Cl. 279/131; 433/127

(57) ABSTRACT

This invention is a centrifugal chuck mechanism for holding “dental drill bits” (hereinafter referred to as “burr or burrs”) tightly in an air turbine cartridge which are part of a handheld dentists' tool (hereinafter called a “hand-piece”) of the type that rotates a burr which has a cutting head for removing tooth structure. The air turbine cartridge includes a burr sleeve into which the burr can be easily inserted with one hand and is held safely in place until rotation begins. Upon rotation of the air turbine cartridge, centrifugal forces lock the burr in position and as the revolutions increase the burr is locked tighter and tighter precluding the migration of the burr out of the hand-piece.

### BACKGROUND OF INVENTION

1. Field of the Invention

This invention relates to a centrifugal chuck device for holding a dental burr in a high speed dental hand-piece.

2. Description of the Prior Art

Dental hand-pieces used to drive such instruments as burrs, are powered by a variety of sources (pneumatic, electric, etc.) and are produced in a variety of shapes and sizes to best accommodate the device to a particular dental procedure. Hand-pieces have been in common usage for several decades and have used many methods of securing a burr in a hand-piece.

One method of securing a burr relies on a separate manual operation and a separate tool to tighten the chuck. Not only are extra steps necessary prior to use this method but the necessary tool just adds clutter or may not be available when it is needed. Of necessity, there is an opening in the back end of the head of the hand-piece through which the tool for tightening the chuck must enter. This allows contaminants to enter or be drawn into the interior of the hand-piece. In addition the flat surfaces on the burr sleeve in the front of the head of the hand-piece necessary to hold the chuck from turning while the tool tightens the chuck, can cause soft tissue damage if in contact with it. This type of chuck has been known to loosen at high speed thereby allowing the burr to escape while in use. It would be preferable to simplify the chuck to automatically engage and firmly grip the burr shaft, have no opening in the back of the head of the hand-piece and have a smooth concentric design.

A second method of securing a burr relies on a push button on the back end of the head of the hand-piece. The button is pushed with the thumb of one hand while the burr is inserted with the fingers of the other. This is an improvement over the previous method since it reduces the steps necessary to engage the burr. However, there is no seal in the back of the head of the hand-piece which still allows contaminants to enter there. In addition, if the push button is depressed by contact with mouth tissues and makes contact with the rotating parts inside, there will be heat buildup which could cause tissue burns. At high speed this method has been known to allow the bur to migrate out of the front entry of the hand-piece. Additionally, this process still requires two hands to complete the process of inserting and gripping the burr. It would be preferable to place the burr into the chuck with one hand and have the chuck tighten incrementally and securely as the speed of rotation increases.

Another method of securing a burr relies on the use of centrifugal chucks. Because of the limited space in a dental hand-piece, most of the centrifigal chucks as found in prior art cannot be used in a dental hand-piece. Others are not compatible with the high speeds of dental hand-pieces. Still others are so complicated that to miniature them for dental hand-pieces would increase the cost of fabrication beyond feasibility if they could be fabricated at all. Others require frequent maintenance that may require replacement of parts. It would be preferable to produce a simplified centrifugal chuck with fewer parts, that does not require any maintenance and that will fit into a small space within the head of a dental hand-piece (approx. 3.2 mm wide and 11.5 mm in diameter) and can function at the highest speed of a dental hand-piece.

It is therefore an object of this invention to produce an automatic chuck for use with a dental hand-piece.

It is also an object of this invention to produce an automatic chuck which has no opening and is hermetically sealed on the back of the head of the hand-piece.

It is also an object of this invention to produce an automatic chuck which is centrifugally operated.

It is also an object of this invention to produce a centrifugally operated chuck which has fewer components than prior art centrifugally operated chucks.

It is also an object of this invention to produce a centrifugally operated chuck which has a maximum width less than that of prior art centrifugally operated chucks.

It is also the object of this invention to produce a centrifugally operated chuck which can withstand the highest speed of a dental hand-piece.

It is also the object of this invention to produce a centrifugally operated chuck which simplifies the insertion of the bur.

It is also an object of this invention to produce a centrifugally operated chuck which is adapted to engage a burr shaft even when stationary.

It is further an object of this invention to produce a centrifugally operated chuck which increases the chucking forces on the burr as the speed of rotation increases

It is further an object of this invention to produce a centrifugally operated chuck which increases the chucking forces on the burr as the torque on the burr and speed of rotation increases

### SUMMARY OF THE INVENTION

This invention is a chuck mechanism for holding dental burrs tightly in an air turbine cartridge which is part of a hand-piece of the type into which the shank of the burr is inserted. The air turbine cartridge includes a burr sleeve into which the burr is inserted and has three holes strategically and concentrically arranged and equally spaced around the burr sleeve through which the tips of the locking weights move at right angles to the burr shank and thereby pressures can be placed on the burr shank locking it in place.

In the preferred embodiment of the centrifugal bur chuck, in the resting non-rotating position of the air turbine cartridge, the steel springs made of the thinnest metal possible to move the tips of the locking weights radially away from the central opening in the burr sleeve as a function of the fulcrums created in the burr sleeve by the three holes machined in the burr sleeve, thereby allowing the burr to be placed into the burr sleeve without the locking weights blocking its entry.

A method of securing the burr prior to commencing rotation would be achieved by the use of a collet that has been machined into the open end of the burr sleeve that has four tongues created by four slots and made of the appropriate spring metal which allows the four tongues to spring back or forth if pressure is placed on the tip of the tongue. On the inner surface of the tip of the tongues is machined a circumferential rounded collar or rim that will provide a positive stop indicated by an audible click when engaged into a circular groove of the same dimension that has been machined into the outer surface of the burr shank. This will produce some resistance to the insertion of the drill and provide enough retention when the groove and collar are engaged to hold the drill in place when commencing rotation of the air turbine cartridge.

Upon rotation of the air turbine cartridge, centrifugal forces placed on the locking weights by virtue of the greater mass on the opposite side of the filcrums to the locking tips will move the locking tips toward the central axis of rotation thereby locking the burr in position. The tips of the locking weights are knurled and hardened to further reduce slippage of the burr. As the revolutions per minute increase, the burr is locked tighter and tighter from the centrifugal forces. As the torque on the burr increases, the burr is locked tighter and tighter as a result of the slope on the tips of the locking weights that provides a mechanically advantage or logarithmic increase of pressure. This is desirable since other methods of locking burrs tend to get looser as the revolutions per minute increase and could allow the burr to escape from the burr sleeve at detriment to a patient.

### BRIEF DESCRIIPTION OF DRAWINGS

FIG. 1 is a side view cutaway of a dental hand-piece that shows the position of the centrifugal burr chuck (#1).

FIG. 2 shows an air turbine cartridge removed from the hand-piece showing the component parts and the position of the centrifugal burr chuck (#1).

FIG. 3 is a disassembled view of an air turbine cartridge showing the position of the centrifugal burr chuck (#1).

FIG. 4a is an end view of the preferred embodiment of the centrifugal burr chuck in an assembled state. This embodiment has attached springs.

FIG. 4b is an end view of another embodiment of the centrifugal burr chuck in an assembled state. This embodiment has floating springs.

FIG. 5a is an exploded view of the preferred embodiment showing the relative positions of the pieces of the centrifugal burr chuck. This embodiment has attached springs.

FIG. 5b is an exploded view of another embodiment showing the relative positions of the pieces of the centrifugal burr chuck. This embodiment has floating springs.

FIG. 6is the burr sleeve into which the collet has been machined.

### DETAILED DESCRIPTION OF THE INVENTION

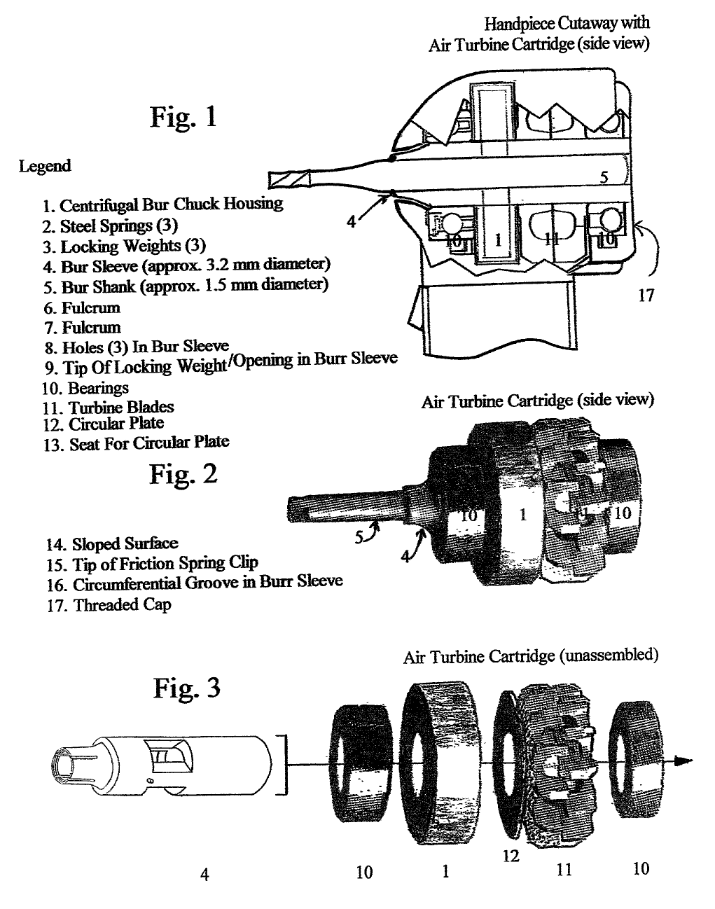

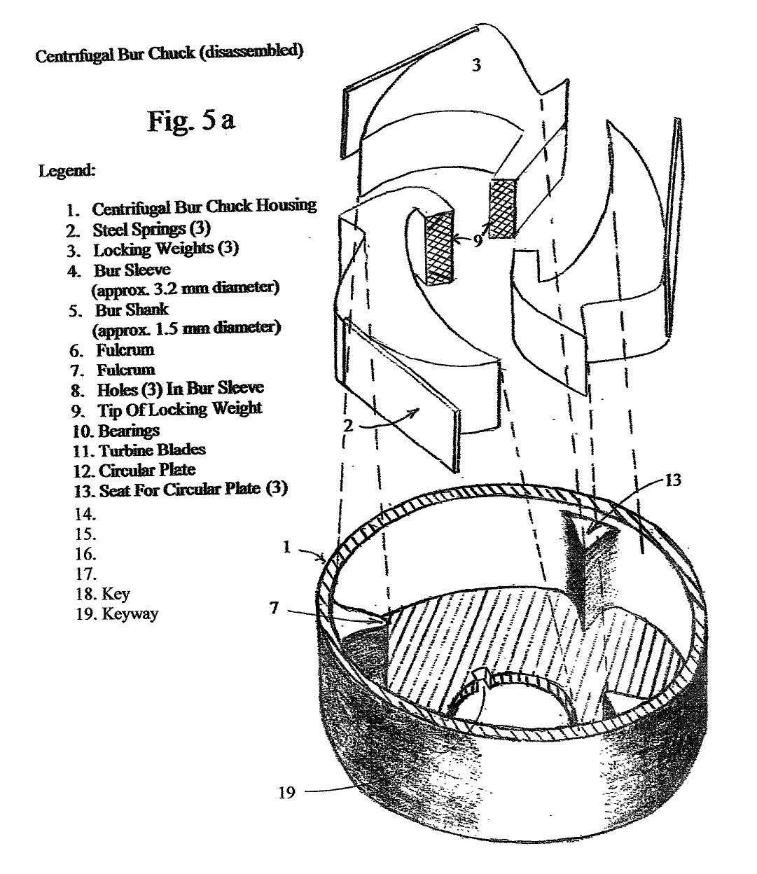

The centrifugal burr chuck (FIGS. 4&5) comprises a housing (#1), three locking weights (#3), springs (#15) and a circular plate (#12) and is useful in any type of high-speed (300,000+ rpm) air driven dental hand-piece (FIG. 1). This chuck is designed to replace other methods of holding and locking a dental burr (#5) in place while it is rotating to remove tooth structure. This chuck requires only one hand to insert the burr (#5), holds the burr in place prior to use, locks the burr tighter as the speed of rotation and torque increases and is designed for the highest rpm of any dental hand-piece.

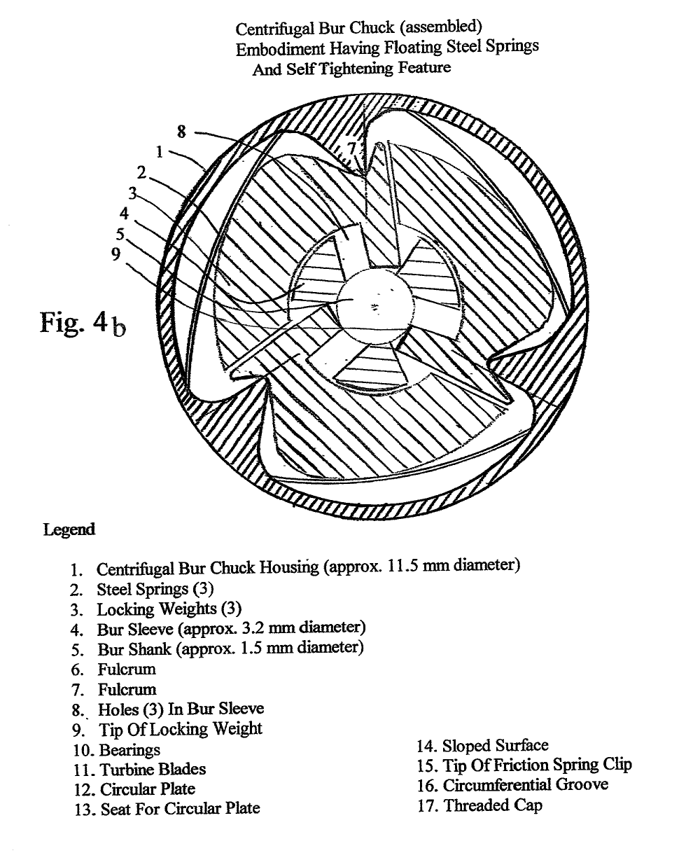

FIG. 1 shows a common configuration of many hand-pieces that are presently in use except that the centrifugal burr chuck has been strategically placed in the mid to forward location between the front bearing (#10) and the air turbine blades (#11) to allow extending the burr out of the handpiece while still able to lock it in position. All parts including the front bearing (#10), the chuck (#1), the circular plate (#12), air turbine blades (#11), and back bearing (#10) are pressed onto the burr sleeve (FIG. 3 #4) and fixedly rotate with the burr sleeve (#4) on the bearings (#10) and are propelled by a stream of air engaging the turbine blades (#11).

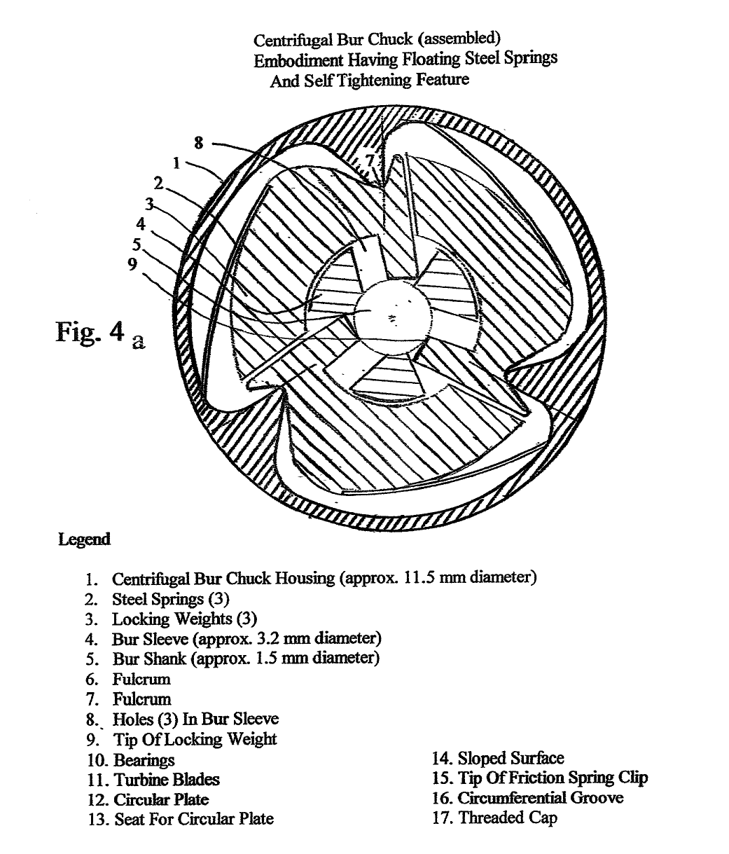

This fixedly assembled group called an air turbine cartridge (FIG. 2) is inserted in the back end of the head of the hand-piece after a threaded cap (#17) is removed to allow passage of said cartridge into the head of the hand-piece as in FIG. 1. An alteration is machined into the burr sleeve which includes three holes, (FIG. 3 #8, FIGS. 4&5 #9), strategically and concentrically arranged and equally spaced around said burr sleeve (#4) through which the tips (FIGS. 4&5 #9) of said locking weights (FIGS. 4&5 #3) move freely at right angles to said burr shank (#5). Said circular plate (FIG. 3 #12) closes the open side of the housing (#1) resting on the three seats (#13) prepared for it, thereby holding the three locking weights (#3) in position in readiness for begining rotational operation.

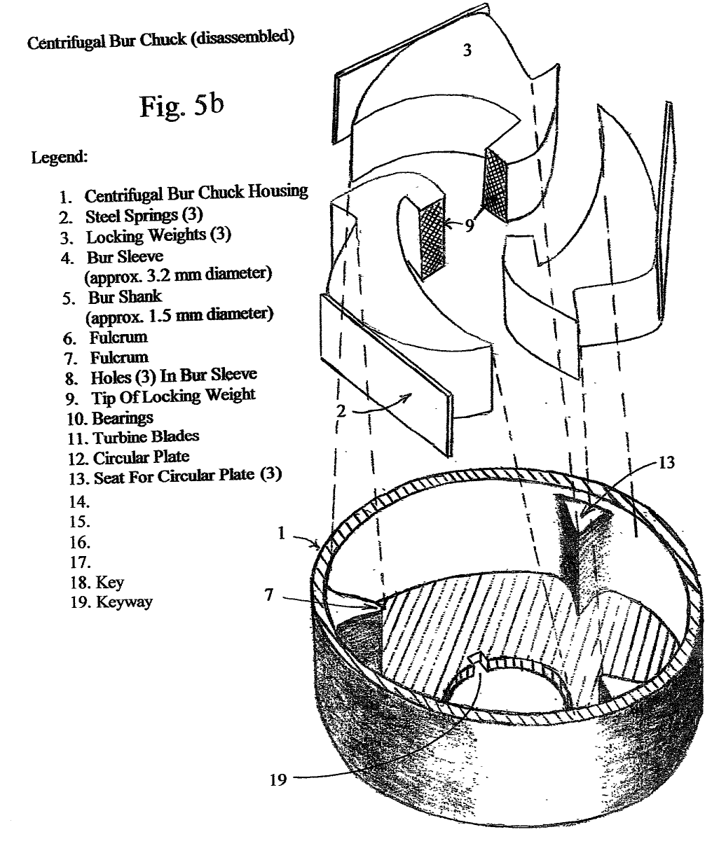

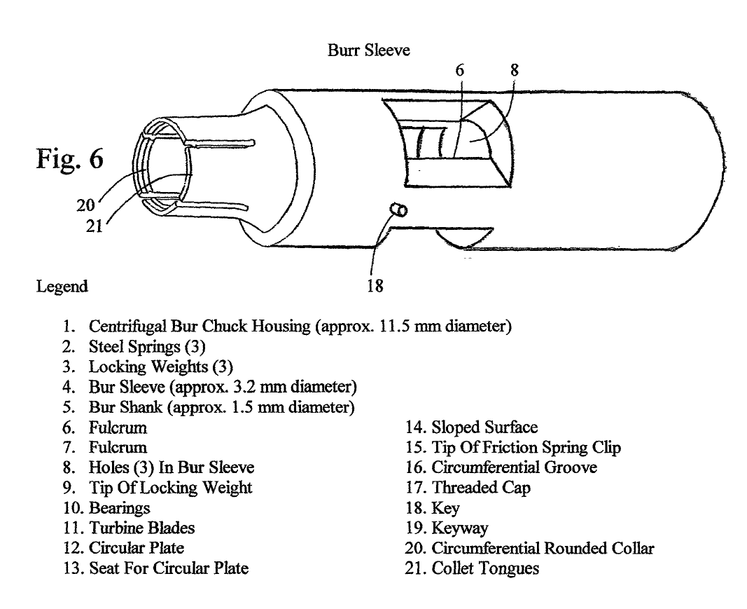

The housing should be made of rust resistant material of sufficient strength, both in thickness and type of material to withstand deformation by the forces placed in it by the three locking weights when rotated at 300,000 to 400,000 revolutions per minute. The fulcrum (#7) that is an integral part of the housing should extend inwardly approximately two mm with one side of the protrusion on a radius line and the other side forming approximately a 60 degree angle to the first side. The central opening of the housing should be small enough to be able to be pressed onto the bur sleeve. A keyway (FIG. 5 #19) that has been machined into said central opening of the housing will mate precisely with the key (FIG. 6 #18) that has been placed into the exterior of the burr sleeve (FIG. 8.) and will hold the two pieces in the exact position for the correct function of the locking weights under any rpm or load. The circular plate (#12) should be of similar thickness of material as the housing and fit precisely into the open side of the housing and rest firmly onto the seats (FIG. 5 #13) in the housing. The diameter of the housing should be slightly smaller then the inside of the head of the hand-piece which is approximately 11.5 mm.

The locking weights (#3) should be of a rust resistant material. The thickness should be approximately 2 mm. or wider if room allows. The tips (#9) of these locking weights should be serrated (as in U.S. Pat. No. 4,611,990) and of a hard material that can withstand wear during use and have a slope that will cause increased pressure as the torque on the burr increases.

The steel springs (#2)should be made of a rust resistant material that will withstand thousands of deformations without loss of shape or fatigue. Additionally, the springs should be of the same width as the locking weights and have the minimum thickness necessary to move and hold the tips of the locking weights away from the central opening of the burr sleeve in the stationary mode to allow the bur to be placed.

In the preferred embodiment of the centrifugal chuck (FIGS. 4a and 5a), steel springs (#2) of the same width as the locking weights are fixedly attached to the locking weight as shown in the diagram. When these locking weights with the springs attached are inserted into the housing the forces placed on the locking weights by the springs will move the tips radially away from the center of rotation and thus allow the burr to be placed into the burr sleeve without blockage.

The second embodiment of the centrifigal burr chuck (FIG. 4c) is similar to the first embodiment except that the springs are not attached, float in a confined space, and perform the same function as in the first embodiment.

A method of securing the burr prior to commencing rotation would be achieved by the use of a collet that has been machined into the open end of the burr sleeve. Said collet has four tongues created by four slots and made of the appropriate metal which allows the four tongues to spring back or forth if pressure is placed on the tips of the tongue. On the inner surface of the tips of the tongues is machined a circumferential rounded collar or rim that will provide a positive stop indicated by an audible click when engaged into a circular groove of the same dimension that has been machined into the outer surface of the burr shank. A burr may have multiple circular grooves machined into the exterior of it's shank to allow positioning the burr further out of the handpiece. No groove should be placed in a position which would not allow the centrifugal burr chuck to lock the burr in place. Upon inserting the burr there will be some resistance to the insertion of the burr and provide enough retention when the groove and collar are engaged to hold the drill in place when commencing rotation of the air turbine cartridge.

Upon rotation of the air turbine cartridge, centrifugal forces placed on the locking weights by virtue of the greater mass on the opposite side of the fulcrums to the locking tips will move the locking tips toward the central axis of rotation thereby locking the burr in position. As the revolutions per minute increase the burr is locked tighter and tighter from the centrifugal forces. As the torque on the burr increases the burr is locked tighter as a result of the mechanical advantage by virtue of the slope on the locking tips. In addition, the tips of the locking weights are knurled and hardened to further reduce slippage of the burr. This is desirable since other methods of locking burrs tend to get looser as the revolutions per minute increase and could allow the burr to escape from the burr sleeve at detriment to a patient.

What is claimed is:

1. A centrifugal chuck mechanism for securing a grinding means shaft more conveniently and securely inside a rotatable hollow drive sleeve that is part of a driving means comprising:
a circular housing radially situated to and fixedly rotating with said hollow drive sleeve about a longitudinal axis;
locking weights situated inside said circular housing having radial movements guided by fulcrums, springs and centrifugal forces;
a circular plate for closing the opening to said circular housing and holding said locking weights securely yet allowing them to move freely inside said circular housing,

2. a chuck mechanism of claim 1 in which an embodiment of said locking weights have springs that moves the tips of the said locking weights away from the central axis of rotation thus allowing said grinding means shaft to be inserted into said hollow drive sleeve,

3. a chuck mechanism of claim 1 wherein a friction means is situated internally in said hollow drive sleeve to keep said grinding means from falling out prior to use,

4. a chuck mechanism of claim 1 in which said tips of said locking weights are constructed of a serrated, hard and nonerodable material,

5. a chuck mechanism of claim 1 upon rotation of said chuck mechanism, because of the greater mass of said locking weight on the opposite side of one of said fulcrums from said tips, centrifugal forces will cause said tips of the said locking weights to move radially toward the central axis of rotation, thereby locking said grinding means to said hollow drive sleeve in anticipation of high speed rotation by which said grinding means is used to remove portions of various materials,

6. a chuck mechanism of claim 1 in which the tips of said locking weights have a mechanically advantaged slope that tightens logarithmetically on the said shaft of said grinding means as the torque and the revolutions per minute increase.
